(19) United States
(12) Patent Application Publication
(10) Pub. No.: US 2019/0164065 A1
(43) Pub. Date: May 30, 2019

(54) Systems and Methods Venue Visitation Forecasting

(71) Applicant: DEXIBIT LIMITED, Auckland (NZ)

(72) Inventors: Adnaan Velji, Auckland (NZ); Alexandria Garkavenko, Auckland (NZ); Angelene Kylie Judge, Auckland (NZ); Norman Boon Chew Yap, Auckland (NZ)

(21) Appl. No.: 16/201,209

(22) Filed: Nov. 27, 2018

(30) Foreign Application Priority Data
Nov. 27, 2017 (NZ) 737788

(51) Int. Cl. G06N 5/02; G06N 20/00; G06Q 10/02

(52) U.S. Cl. CPC G06N 5/02; G06Q 10/02; G06N 20/00

(57) ABSTRACT

A system and method for the computerized forecasting of venue, visitation based on data comprising historic visitation data and a contextual data set comprising a set of defined factors, the system and method including the building of a venue forecasting model incorporating machine learning, and using the venue forecasting model to generate a venue forecast by applying the model to future contextual data.

### CROSS REFERENCE TO RELATED APPLICATIONS

This application claims priority to New Zealand provisional patent application no. 737788, entitled “Systems and Methods for Data Intelligence Using Machine Learning” and filed on Nov. 27, 2017. Such application is incorporated by reference in its entirety.

### FIELD OF THE INVENTION

The present disclosure, in various embodiments, relates to big data analytics, and more particularly relates to the forecasting of venue visitation.

### BACKGROUND TO THE INVENTION

Organizations typically accumulate large amounts of data, with different data created for different purposes and by different sources. Data intelligence involves analysis of that data for purposes such as big data analytics. Even if portions of data storage and organization may be automated, a user typically reviews the data, draws extrapolations and conclusions, then makes imprecise manual approximations and assumptions.

Venues are one type of business who may often present an event such as an exhibition, show or display with the desire to maximize attendance and achieve other commercial or social objectives.

There is a desire to be able to use recorded data to forecast future visitation at the venue or another similar venue. It is an object of the present invention to address this desire, or go at least some way toward providing the public with a useful choice. Other objects of the invention may become apparent from the following description which is given by way of example only.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

### SUMMARY OF THE INVENTION

According to some, broad embodiments the invention relates to a method of computerized forecasting of venue visitation based on data comprising historic visitation data and a contextual data set comprising a set of defined factors, wherein each of the data sets comprises temporal reference data, wherein the method comprises the computerized building of a venue forecasting model comprising the steps of: (a) receiving the historic visitation data including temporal reference data, (b) receiving the contextual data set comprising a set of defined factors, each of the set of defined factors having, temporal data overlapping, at least in part, to the historical data temporal reference, (c) application of a machine learning process to determine the influence associated with each defined factor in the contextual data set to the historic visitation data for overlapping, at least in part, a temporal reference, and (d) generating the venue visitation forecasting model based on the determined influence associated with each defined factor, and wherein the method further comprises application of the venue visitation forecasting model to generate a visitation forecast by the steps of (a) receiving a future temporal reference for the desired visitation forecast and future contextual data set for at least the future temporal reference, (b) applying the forecasting model to the future contextual data for the future temporal reference to thereby produce a venue visitation forecast, and (c) generating an output indicative of the venue visitation forecast for at least the future temporal reference.

In some embodiments, the contextual data set is produced by a data cleansing process comprising the steps of (a) preparation of the defined set of factors by a process of selecting factors from a broader contextual data set based on one or more criteria and (b) receiving control inputs from an operator to provide interactions operable to classify a state associated with each defined factor in the contextual data set.

In some embodiments, the step to classify a state comprises (a) application of a filter to create overlapping, at least in part, temporal reference data associated with each factor in the defined set of factors, and/or (b) interpolation and/or extrapolation of missing data, then (c) quantizing one or more raw factor data variables to a defined state.

In some embodiments, the influence associated with each defined factor comprises generating a hierarchy of defined factors in the contextual data set.

In some embodiments, determining the hierarchy comprises determining a weighting parameter for each of the defined factors in the contextual data set.

In some embodiments, the historic visitation data comprises historic data from two or more venues.

In some embodiments, the machine learning process comprises a combination of or ranking of two or more machine learning models.

In some embodiments, the historic visitation data and a contextual data set comprises at least one year of temporal data.

In some embodiments, the historic visitation data comprises footfall or attendance data at one or more venues, and the temporal reference data comprises time of day, including time intervals of a minute, minutes, an hour, and/or hours.

In some embodiments, the defined factors in the contextual data set comprises Type of day (weekday or weekend), Day of week, Month, Season, School term, Public holiday, and Internal exhibition or event at the venue.

In some embodiments, the defined factors in the contextual data set further comprises: external special regional event.

In some embodiments, the defined factors in the contextual data set further comprises: weather data, weather state data, and cruise ship docking data.

In some embodiments, the defined factors in the contextual data set further comprises at least one of: year on year variation, marketing spend, and local tourism populations.

In some embodiments, the venue visitation forecasting model is generated by a process comprising: (a) application of a machine learning process to a first temporal portion of the historical visitation data set and the contextual data set to thereby determine a preliminary venue visitation forecasting model based on said first temporal portion; (b) testing the determined venue visitation forecasting model based on the first temporal portion to the remaining temporal portion of the historical visitation data set and the contextual data set to thereby determine a fit parameter representing the accuracy of the venue visitation forecast and the remaining temporal portion of the historical visitation data set; (c) repeating steps (a), (b) for different temporal portions of the of the historical visitation data set; and (d) refining the venue visitation forecasting model based on the fit parameter.

According to another broad embodiment, the invention relates to a system configured for the computerized forecasting of venue visitation based on data comprising historic visitation data and a contextual data set comprising a set of defined factors; each of the data sets comprises temporal reference data, the system comprising memory and a processor, wherein the memory is configured to store historic visitation data including temporal reference data and contextual data set comprising a set of defined factors, each of the set of defined factors having temporal data overlapping, at least in part, to the historical data temporal reference; and wherein the processor is configured to execute instructions to compute a computerized building of a venue forecasting model, including the steps of: (a) application of a machine learning process to determine the influence associated with each defined factor in the contextual data set to the historic visitation data for overlapping, at least in part, a temporal reference; (b) generating the venue visitation forecasting model based on the determined influence associated with each defined factor, and wherein the instructions further comprise application of the venue visitation forecasting model to generate a visitation forecast by the steps of: (a) receiving a future temporal reference for the desired visitation forecast and future contextual data set for at least the future temporal reference; (b) applying the forecasting model to the future contextual data for the future temporal reference to thereby produce a venue visitation forecast; and (c) generating an output indicative of the venue visitation forecast for at least the future temporal reference.

According to another broad embodiment, the invention relates to a method of generating a building control signal carrying information indicating or predicting occupants in a building based on data comprising historic visitation data and a contextual data set comprising a set of defined factors, wherein each of the data sets comprises temporal reference data, wherein the method comprises the computer processor implemented building of a venue forecasting model comprising the steps of: (a) directing, via a control interface, the processor to receive the historic building visitation data including temporal reference data;

directing, via a control interface, the processor to receive the contextual data set comprising a set of defined factors, each of the set of defined factors having temporal data overlapping, at least in part, to the historical data temporal reference; (b) directing, via a control interface, the processor to implement a machine learning process to determine the influence associated with each defined factor in the contextual data set to the historic visitation data for overlapping, at least in part, a temporal reference; (c) directing via a control interface, the processor to generate the building visitation forecasting model based on the determined influence associated with each defined factor; and wherein the method further comprises application of the building visitation forecasting model to generate a visitation forecast by the steps of: (a) inputting to the forecasting model, via a control interface, a future temporal reference for the desired building visitation forecast and future contextual data set for at least the future temporal reference to thereby produce a building visitation forecast; then (b) generating the building control signal based on the building visitation forecast for the future temporal reference.

In some embodiments, the building control signal is operable to facilitate control of one or more building amenities.

In some embodiments, the method further comprises control of one or more building amenities based on the building control signal.

In some embodiments, the processor is configures to receive new historic visitation data and a contextual data set; and the method further comprises generating a new building control signal based on the new data.

In some embodiments, there is a system for generating a forecast of visitation at a venue, the system comprising: (a) a processor and (b) a memory adapted to store machine readable instructions configured for execution by the processor, and a set of factors comprising data relating to historic visitation, and the processor configured to: (a) analyse the set of factors to determine a hierarchy of the factors; (b) generate a forecasting model based on the determined hierarchy of factors; and (c) apply the forecasting model to the historic data to thereby forecast visitation at the venue.

In some embodiments, there is a processor-readable medium having stored thereon processor-executable instructions which, when executed by a processor, cause the processor to perform a method of forecasting visitation at a venue, the method comprising: (a) analysing a set of data comprising factors relating to historic visitation at the venue to determine a hierarchy of the factors; (b) generating a forecasting model based on the determined hierarchy of factors; and (c) applying the forecasting model to the historic data to thereby forecast visitation at the venue.

In some embodiments, there is a method operable on a processor for forecasting visitation at a venue, the method comprising (a) receiving a data set relating to the venue, the data set comprising a set of factors, (b) receiving an indication of a time period desired to be forecasted, (c) applying the data set to a forecasting model to thereby generate forecasted visitation data; and (d) outputting the visitation data.

In some embodiments, there is a method for forecasting visitation at a venue, the method comprising: (a) analysing a set of data comprising factors relating to historic visitation at the venue to determine a hierarchy of the factors; (b) generating a forecasting model based on the determined hierarchy of factors; and (c) applying the forecasting model to the historic data to thereby forecast visitation at the venue.

In some embodiments, the method comprises determining the hierarchy of factors comprises determining a weighting parameter for each factor of the historic data set.

In some embodiments, the venue comprises two or more venues.

In some embodiments, the step of analysing the set of data comprises a machine learning process.

In some embodiments, the forecasting model is based on a selection of the set of factors.

In some embodiments, the machine learning process comprises analysis of two or more machine learning models.

In some embodiments, the historic data set comprises at least one year of temporal data.

In some embodiments, the set of factors comprises: (a) Visitation, including footfall or attendance data; (b) Time of day, including time intervals of a minute, minutes, an hour, hours; (c) Type of day (weekday or weekend); (d) Day of week; (e) Month; (f) Season; (g) School term; (h) Public holiday; and (i) Internal exhibition or event at the venue.

In some embodiments, the set of factors further comprises external special regional event.

In some embodiments, the set of factors further comprises at least one of: (a) Weather data; (b) Weather state; and (c) Cruise ship docking.

In some embodiments, the set of factors further comprises at least one of: (a) Year on year variation; (b) Marketing spend; and (c) Local tourism populations.

In some embodiments, the forecasting model is generated by a process comprising: (a) applying a machine learning model to a first temporal portion of the historical data set to thereby determine a forecasting model based on said portion; (b) applying the determined forecasting model to the remaining temporal portion of the historical data set; (c) determining a parameter representing the fit between the forecasted visitation data and the remaining temporal portion of the historical data set; (d) applying a criteria to the fit parameter; and (e) storing the determined forecasting function.

In some embodiments, the machine learning model is selected from a set of machine learning models, and the process further comprises

In some embodiments, the forecasting model is generated by a process further comprising generating a forecasting model using each machine learning model in the set of machine learning models

wherein the criteria comprises: (a) a trend; and/or (b) a result indicative of inaccuracy.

In some embodiments, the method further comprises optimizing the forecasting model by the steps of: (a) applying a machine learning process to a fractional temporal portion of the historical data set to thereby determine a forecasting model based on said portion; (b) applying the determined forecasting model to the remaining fractional temporal portion of the historical data set; (c) repeating steps (a), (b) for different fractional amounts; and (d) storing the determined forecasting model. In some embodiments, steps (a), (b) are repeated ten times.

In some embodiments, the method further comprises optimizing the function comprising: (a) applying a machine learning model to a first portion of the historical data set to determine a forecasting model based on the first portion; (b) comparing the determined forecast to the remaining portion of the historical data set and determining a fit parameter; (c) updating the forecasting model based on the fit parameter; (d) applying a machine learning model to a second portion of the historical data set to determine a forecasting model based on the second portion; (e) comparing the determined forecast to the remaining portion of the historical data set and determining a fit parameter; and (f) updating the forecasting function based on the fit parameter.

In some embodiments, the method further comprises optimizing the function comprising: (g) applying a machine learning model to a variety of portions of the historical data set to determine a forecasting function based on the portions; (h) comparing each of the determined forecasts from the variety of portions to the remaining portion of the historical data set; (i) determining fit parameters for one or more of the variety of portions; and (j) updating the forecasting function based on the one or more of the fit parameters.

In some embodiments, the invention relates to any one or more of the above statements in combination with any one or more of any of the other statements. Other aspects of the invention may become apparent from the following description which is given by way of example only and with reference to the accompanying drawings.

The entire disclosures of all applications, patents and publications, cited above and below, if any, are hereby incorporated by reference. This invention may also be said broadly to consist in the parts, elements and features referred to or indicated in the specification of the application, individually or collectively, and any or all combinations of any two or more, of said parts, elements or features, and where specific integers are mentioned herein which have known equivalents in the art to which this invention relates, such known equivalents are deemed to be incorporated herein as if individually set forth.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the several views.

FIG. 1 depicts a system for the application of data intelligence specific for the forecasting visitation at a venue.

FIG. 2 shows a visitation attendance forecasting processing engine.

FIG. 3 shows a process where the forecasting model is generated.

FIG. 4 shows a visitation forecasting process.

FIG. 5 shows a graphical illustration of how forecasted visitation data may be presented.

FIG. 6 shows a process of maintaining ongoing accuracy of a forecasting model.

### DETAILED DESCRIPTION OF THE INVENTION

Exemplary methods and systems are described herein. It should be understood that the word “exemplary” is used herein to mean “serving as an example, instance, or illustration.” Any embodiment or feature described herein as “exemplary” or “illustrative” is not necessarily to be construed as preferred or advantageous over other embodiments or features. More generally, the embodiments described herein are not meant, to be limiting. It will be readily understood that certain aspects of the disclosed systems and methods can be arranged and combined in a wide variety of different configurations, all of which are contemplated herein.

The term “and/or” referred to in the specification and claim means “and” or “or”, or both. The term “comprising” as used in this specification and claims means “consisting at least in part of”. When interpreting statements in this specification and claims which include that term, the features, prefaced by that term in each statement all need to be present but other features can also be present. Related terms such as “comprise” and “comprised” are to be interpreted in the same manner.

The term “system” referred to in the specification and claims may comprise software, hardware, or a combination thereof. For example, the software can be machine code, firmware, embedded code, and application software. Also for example, the hardware can be circuitry, processor, computer, integrated circuit, integrated circuit cores, active or passive sensors or sensing equipment, or a combination thereof.

The term “user” referred to in the specification and claims refers to an individual such as a person, or a group or people, or a business such as a retailer or advertiser of one or more a products or services. The primary meaning of “user” referred to in the specification and claims is the recipient of video and/or audio sources. However, “user” may also refer to provider of video or audio sources.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Many of the functional units described in this specification have been labelled as modules, in order to more particularly emphasize their implementation independence. For example, a module may be implemented as a hardware circuit specialized circuits, gate arrays, purpose specific semiconductors such as preprogrammed for function microprocessors, logic chips, transistors, or other discrete components, or a combination of these components. A module may also be implemented in programmable hardware devices such as field programmable gate arrays, programmable array logic, programmable logic devices or other similar devices.

Modules may also be implemented in software for execution by various types of processors. An identified module of executable code may, for instance, comprise one or more physical or logical blocks of computer instructions which may, for instance, be organized as an object, procedure, or function. Further, an identified module need not be physically located together, but may comprise disparate instructions stored in different locations which, when joined logically together, comprise the module and achieve the stated purpose for the module.

A module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network, Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing. More specific (non-exhaustive) examples of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a magnetic disk, a magnetic storage device, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on a user computer, partly on a user computer, as a stand-alone software package, partly on a user computer and partly on a remote computer or entirely on the remote computer or server. In the latter scenario, a remote computer may be connected to a user's computer through any type of network, including a local area network (LAN) or a wide area network (WAN), or the connection may be made to an external computer, for example, through the Internet using an Internet Service Provider.

Further, the term network is generally used to describe a means through which data is transported from one location or module to another. In this context, the network may equally include the transportation of data by writing that data to a transportable form of computer readable storage media, and relocating that storage from one physical location to another.

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The embodiments discussed herein incorporate systems and methods which predict the attendance at a venue, based on a series of variables as appropriate to that venue. When building a machine learning model, this is known as feature selection. The description of elements in each figure may refer to elements of proceeding figures. Like numbers refer to like elements in all figures, including alternate embodiments of like elements.

In accordance with the below described embodiments, there is presented a system and method for accurately predicting event attendance at a particular venue for a particular time of the year. Further, with some specific data being considered, future event attendance can be determined for particular seasons, months, days and/or times of the day. The forecast knowledge determined by methods discussed herein can be leveraged to determine, for example, an optimum time of the year to show an exhibit, an optimum duration for an exhibit, or both. Further, there forecast knowledge is determined, particular aspects of the venue can be tailored to suit the predicted number of people who may attend a venue.

Where a venue has tangible amenities, those amenities could be controlled based on the forecast attendance. For example, features of a smart building could be controlled based on the forecast attendance data. Amenity control includes control of building features such as ventilation equipment for heating or cooling, proactive maintenance of equipment, dynamic power consumption, and the provision of electrical facilities such as elevators, lighting, and media equipment.

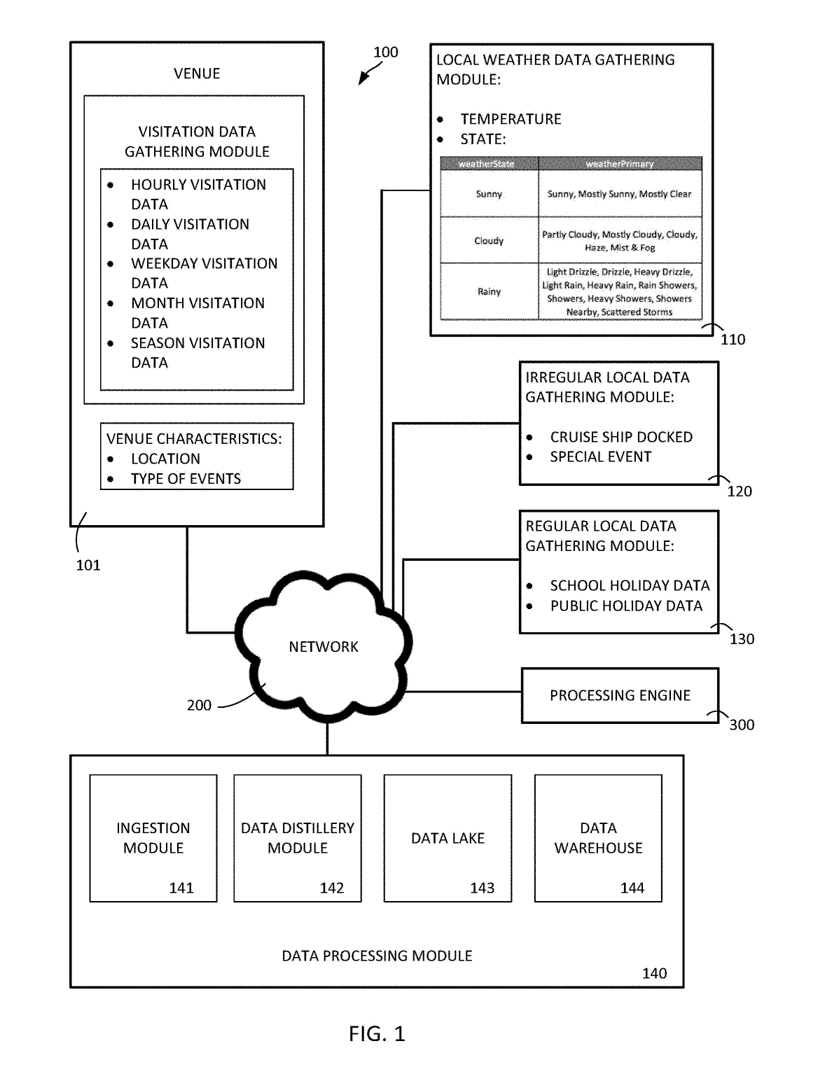

FIG. 1 depicts one exemplary embodiment of a system 100 for the application of data intelligence specific for the determination of future event attendance at a venue 101 or control of the venue building. The venue 101 might be a building such as a museum, art gallery, amusement attraction, zoos, parks, aquariums, libraries, theme and amusement parks, tourist meccas, historic sites sports arena or similar defined location where attendance of a venue, exhibition or event is facilitated.

It should be noted that the venue 101 may be a generic venue from which data is gathered and used to determine the future event attendance at another venue. Further, the venue 101 may comprise two or more venues. For example, data from two or more venues may be combined in instances where the venues share many attributes such as geographical location, size, and the types of attraction typically exhibited. Ultimately various forms of data gathered in the system are provided to a processing engine 300 which is tasked with conducting data analysis and determining an outcome indicative of future event attendance.

Data relating to the attendance at the venue is recorded and stored. The venue is typically configured to collect data relating to venue attendance. For example, venue ‘visitation’ or ‘attendance’ may be a measure of footfall (the number of people to physically enter the venue) or admissions (the number of people to receive ticketed entry into the venue). Venue attendance and footfall data may be gathered, for example, by point of sale machines indicating ticket purchases, door counting mechanisms, crowd control hardware systems and other similar devices. Such devices are typically connected to a system clock thereby allowing time and date information to be associated with the attendance and footfall data. In some instances, the collected data is assigned metadata such as: location, hemisphere, opening hours or a scaling factor.

A local weather data gathering module 110 is configured to record weather data local to the venue. The weather module may be implemented by a weather station configured to record data such as temperature, cloud condition and rainfall. Alternatively, weather data may be retrieved from pre-existing weather data made available for public records such as an Internet database. The weather data may be made available with high precision, such as rainfall, cloud condition and temperature data to short time spans such as minute time periods. In some varied embodiments, detail to such precision is not always useful and indicative data will suffice. Therefore, in some embodiments, the weather data may be distilled into a coarse form. Table 111 shows an example of distilled weather data where one of three weather states is determined based on a statistical measure, such as the median weather state on a given day. In the exemplary form shown, a daily weather state is determined to be “Sunny” when the median daily weather is sunny, mostly sunny and mostly clear. Other forms of data, for example, snow or storm, may be relevant to venues subject to more extreme weather conditions.

Methods to determine weather states will be apparent to those skilled in the art and may be derived from sensors such as luminosity sensors configured to provide an electrical indication of the available sunlight at any time. Further, various rainfall sensors and moisture sensing devices are widely understood. In some instances, the venue may record their weather data and integrate that data into their own data collection and processing. However, weather data is generally widely available from a range of third party sources.

In a preferred embodiment, the weather data gathering module 110 is configured to record daily weather statistics comprising a weather state of “sunny”, “cloudy” or “rainy” based on the statistically derived indicative data recorded for a day. Further, a temperature is recorded using a statistically derived measure such as the median temperature for a day. Further weather considerations including rainfall, sunlight hours, cloud cover, humidity, wind chill factor and others may also be included.

An irregular local data gathering module 120 is configured to gather and record the daily occurrences of circumstances that may have an impact on the number of local people and tourists who may have interest and time to attend an event. Factors such as whether there is a cruise ship in town (for coastal towns), or other special regional events such as performing artists or sporting events such including a touring sports team are of a kind generally known to have an impact on venue attendance. Further, public programs, regional events, other exhibitions can be included. Other almanac items are possible.

A regular local data gathering module 130 is configured to gather and record daily occurrences of regular local circumstances such as public holidays and school holidays.

A data processing module 140 is configured to store, and optionally process data recorded at the venue 101; the weather data gathering module 110, the irregular local data gathering module 120 and regular local data gathering module 130. A network 200 is configured to facilitate the transfer of data to the from the data gathering modules to the data processing module 140.

The data processing module is primarily tasked with preparing data recorded by various modules for processing by machine learning. For example, the data processing module comprises an ingestion module 141, a data distillery module 142 and a data lake 143.

The data ingestion module 141 is configured to import data for immediate use or storage in a database. Data can be streamed in real time from any one or more of the modules via the network 200 or ingested in batches from any one or more of the modules, or some combination. When data is ingested in real time, each data item is imported as it is emitted by the source module. When data is ingested in batches, data items are imported in discrete chunks at periodic intervals of time. Further, the data source modules may be numerous and record data in a range of formats. The ingestion engine may process the incoming data into a coherent structure to improve storage efficiency, retrieval speed and processing speed.

In some embodiments, the data distillery module 142 may be implemented to apply one or more further processing techniques to the data received by the ingestion module 141. For example, various data may be received with a particular temporal resolution such as seconds or minutes, whereas for an intended application, a temporal resolution of hours or days may be preferred. In such circumstances, the data distillery module is configured to harmonize the temporal resolution of the data sources. Harmonization may include refining data from each data source to match the temporal resolution, or some multiple. Further, the data distillery module may apply aggregation and one or more other statistical measures to the ingested data, such as the determination of averages, medians, log transformations and other methods commonly used to reduce large data sets to smaller indicative data sets. Further data preparation may include, data is prepared by conversion of data formats; parsing, mapping and bucketing functions, and aggregation.

In some embodiments, the data distillery module 142 also includes the application of venue-specific data transformations, for example, using opening hour filters and scaling factors.

The raw data ingested and processed by modules in the data processing module may be stored in the data lake 143 for later retrieval by the processing engine 300, and may be used to store data directly received from the ingestion module 141. The data lake offers the advantage of making all of the data retrieved from various data collection modules at a single location. A data warehouse 144 will typically be used to store data processed by the data distillery module 142. In some embodiments, the data lake 143 is configured to store at least some data received from the various data sources, then later provide some or all of that stored data to the data distillery module 142 for processing before sending to the processing engine 300. The data warehouse 144 is configured to store data processed by the processing engine 300.

Data is stored in the data warehouse 144, and is typically processed in two ways: either small chunks/in real-time using a stream-processing architecture, or in longer running and larger workloads using a batched architecture. A scheduling system manages the automated collection of most data, while some data is manually uploaded by users at the venues. Data collected using the scheduling system is mostly processed in real-time as it is received. The scheduling system also coordinates and triggers the longer running and periodic workloads, such as the preparing the data for machine learning, and running the machine learning modules.

According to a preferred embodiment, the Visitation Data Gathering Module 101 is an integration pack (automated integration by, for example, an API) or sync pack (manual upload by, for example, a CSV file), as part of the ingestion module, which can be daily, hourly or even more granular (e.g. 15 min intervals or real time). All these visitation data types are the same data (hourly, daily, weekday, month, season, etc), and are mapped against a calendar to assess the impact these factors has on visitation.

Local weather, irregular local data and regular local data together form ‘contextual enrichment’. These two are integration packs, sync packs or otherwise manual data entry into the Ingestion module.

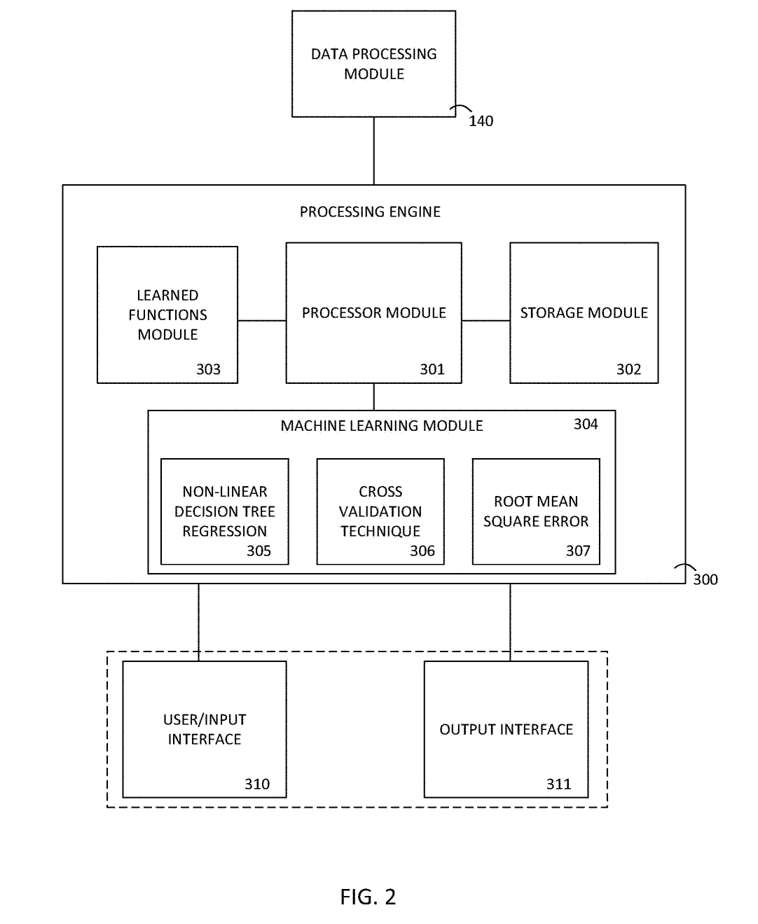

FIG. 2 shows the visitation attendance forecasting processing engine 300 in more detail. In particular, FIG. 2 shows the processing engine 300 connected to the data processing module 140. The processing engine 300 is configured to receive and process data to forecast attendance to an exhibition at a particular venue could occur.

The processing engine 300 comprises a processor 301 configured to undertake computational tasks, interface with other computer modules, receive inputs from a user input interface 310 and provide one or more outputs via an output interface 311 data and graphical displays. The processing engine 301 may incorporate local storage 302 and one or more other modules such as a learned function module 303 and a machine learning module 304. The machine learning module 304 may include any number of machine learning function processing blocks such as a non-linear decision tree regression module 305, a cross validation technique module 306, and a root mean square error module. The machine learning module may incorporate any number of machine learning techniques as may be appropriate for application to data.

Any number of machine learning models can be used for regression analysis are possible. Regression analysis is a statistical process for estimating the relationships among variables, including techniques for modelling and analysing several variables, when the focus is on the relationship between a response variable and one or more independent explanatory variables or predictor variables. Exemplary machine learning models include: (a) Linear regression models, such as least squares; (b) Non-linear regression models such as neural networks and support vector machines; (c) Non-linear decision tree regression models such as random forests and gradient boosted machines; (d) Non-Linear Decision Tree Regression; (e) Gradient Boosted Trees; and (f) eXtreme Gradient Boosting (XGBoost) created by Tianqi Chen.

Linear regression models can be simple and fast, but the simplicity can come at the cost of accuracy. These are best used to model the relationship between a response variable and one or more explanatory variables or independent variables; known as simple linear regression (one variable), or multiple linear regression (more than one variable). Non-linear regression models can be complex and can take a long time to train. These are best used for observational data modelled by a function which is a nonlinear combination of the model parameters and dependent on one or more independent variables.

The processing engine 300 is in communication with data sources such as that of the data processing module 140 or, in some circumstances, directly to one or more data source modules over the data network 200, over a local channel such as a system bus, an application programming interface (API), or the like.

The processing engine 300 is configured to read data from one or more data sources, then use one or more machine learning techniques to identify a relationship between the visitation data and the data from other sources. A resulting or identified relationship can then be used to create learned functions that may provide predictive results based on that data.

The processing engine 300 is configured to identify one or more data sources by an automated scan or in response to an input, and to extract data from the identified data sources such as those stored or prepared by the data processing module 140. The processing engine 300 primarily uses machine learning techniques, as described below, to identify relationships between historic data, evaluate the accuracy of the identified relationships, provide machine learning functions to a user based on selected data, and/or evaluate the predictive performance of the machine learning functions.

According to preferred embodiments, the processing engine 300 is configured to implement a forecasting model for the future attendance at a venue based on historic data of set of factors appropriate to that venue. The forecasting model is operable for use in strategic and operational planning efficiency and accuracy. For example, the forecasting model can be used to predict future visitation or attendance for any day of the year. The attendance prediction facilitates considerations such as the optimum time of the year to show a particular exhibition, and how many staff may be required to be employed.

The forecasting model is operable to forecast attendance admission or footfall visitation for a venue (cultural or entertainment attraction), with a temporal resolution of a monthly, weekly, daily or hourly basis. However, the forecasting model is at least somewhat dependent on the temporal resolution of the data from which the predictions are based.

In some embodiments, the processing engine 300 is configured to incorporate new data to further optimize a forecasting model based on historical data.

In generating the forecasting model, the processing engine 300 is configured to apply at least one machine learning function to a data set and thereby produce a fit parameter. In other embodiments, the processing engine 300 is configured to apply two or more machine learning functions to a data set and evaluate which function produces the closest fit parameter. The machine learning function that produces the closest fit parameter may then be selected as the most accurate function from which the forecasting model is generated. The machine learning functions, or models, may include any one of the above mentioned models.

For visitation attendance forecasting, the primary factors are determined to be required in the data set include a response variable of: (a) Visitation data, including footfall or attendance data; and (b) contextual data comprising: (i) Time of day, including time intervals of a minute, minutes, an hour, hours; (ii) Type of day (weekday or weekend); (iii) Day of week; (iv) Month; (v) Season; (vii) School term; (viii) Public holiday; and (ix) Internal exhibition or event at the venue.

Contextual enrichment data is input data that facilitates accurate prediction model. Contextual enrichment data is required at least for the intended period the prediction is to be applied to. Contextual enrichment data essentially describes what is happening in and around the venue at the time the visitation occurs, or will occur, and therefore may have some impact on the visitation numbers at any particular venue.

To further improve visitation attendance forecasting, the following additional contextual data may be included: (a) External special regional event; (b) Weather data, including temperature, rainfall, sunlight hours, cloud cover, humidity, wind chill factor, and other practical data; (c) Weather state; and/or (d) Cruise ship docking; (e) Year on year variation; (f) Marketing spend; and (g) Local tourism populations.

The visitation and contextual data does not need to be complete, however, the accuracy of forecast models may be improved for complete data sets. Incomplete data reduces the accuracy of forecasts, which can result in under or overestimation, or estimation accuracy instability. To optimize the accuracy of the prediction model, historic recorded data should span at least one year, thereby providing a strong indication of visitation numbers for the next year. If the intended period the prediction is to be applied to a period over two weeks, then weather data is not useful due to its propensity for change.

The objective of the machine learning function is to generate an understanding of each of the above factors and the impact those factors have on the visitation rate of the venue. Considerable analysis of the above factors has enabled the determination of a selection of the above factors that are generally found to have the most significant impact of a visitation at a venue.

Each of the factors in the above set are evaluated for significance by at least one of the machine learning functions. Accordingly, the order of significance of each of the factors determined may be different for each venue.

The data relating to the various factors should be in a form suitable for application to the machine learning model to which they will be provided. Different models require different data formats, and there are various ways to define the data of each factor, For example, “Day of Week” may be arbitrarily set to Monday=1. The particular format of the data is inconsequential to the outcome of the forecasting model. For example, in some instances, boolean expressions may be better expressed as 0 or 1. According to an exemplary embodiment, factors are processed or otherwise transformed into the following form: (a) Visitation: integer values. For daily-granularity forecast, needs to be in aggregate brackets (e.g. defined by the beginning of the hour window, where “hour: 9” defines visitors between the hours of 9 and 10); (b) Hour: must be integer value, given in 24-hour format; (c) Day of week: defined as an integer 1-7 (1=Monday; 7=Sunday); (d) Month: defined as an integer 1-12 (1=January; 12=December); (e) Season: defined as an integer 1-4 (1=Spring); (f) Temperature: defined as an integer in Celsius; (g) Weather state: Weather data must be classified into simplified states, otherwise there is often not enough data points per state to draw conclusions; (h) School holiday: Boolean; (i) Public holiday: Boolean (if public holiday is adjacent to weekend then the weekend is also marked as a public holiday); can also be augmented with the holiday title; (j) Cruise ship docking: Boolean, can also be, augmented with the cruise ship passenger volume; (k) Type of day (weekday or weekend); (l) Special event: Boolean; (m) Internal exhibition or event at the venue: Boolean

A selection of the chosen machine learning algorithm and parameters is closely tuned to the mix of factors and preparation of data provided in the data set.

The required data categories (factors) or the required length (at least a year) are collected and then processed into the appropriate form. The machine learning algorithm then uses each venue-specific dataset to train and test a forecasting model, which is in turn then used for forecasting future venue visitation.

As discussed above, the historic data set is gathered and prepared for application to a machine learning process. Further, a user inputs may be provided to input of date range and duration desired to be predicted, and consideration of which data is relevant.

Often, data cleansing in required to harmonize data sources before application to machine learning model generation. For example, visitation data may be determined by a visitation rule mix which interprets what visitors are counted by which sources, such as ticketed admission, scanned membership cards, footfall counts or a mix. Often multiple technologies are used for footfall counting such as laser, camera or manual. Therefore, a cleansing process is implemented to standardize the data. This process may include standardization of the granularity of data to meet the desired result of the prediction (e.g. ‘hourly’ or ‘daily’), application of opening hours and closed days to this data, application of any scaling factors to this data (an audit factor which lifts or suppresses visitor counts, such as to avoid cleaners/contractors/staff/double entry), changes over time (such as a change of source, at one point in time, or the change of scaling factors or opening hours over time), and noting and refinement or elimination of any data outliers to be avoided in model training.

Contextual factors are also selected based on what might be the most appropriate for a particular value. For example: cruise ships are only useful in a coastal location, and more complex weather data (such as humidity or wind speed) can be used in areas where weather is more influential.

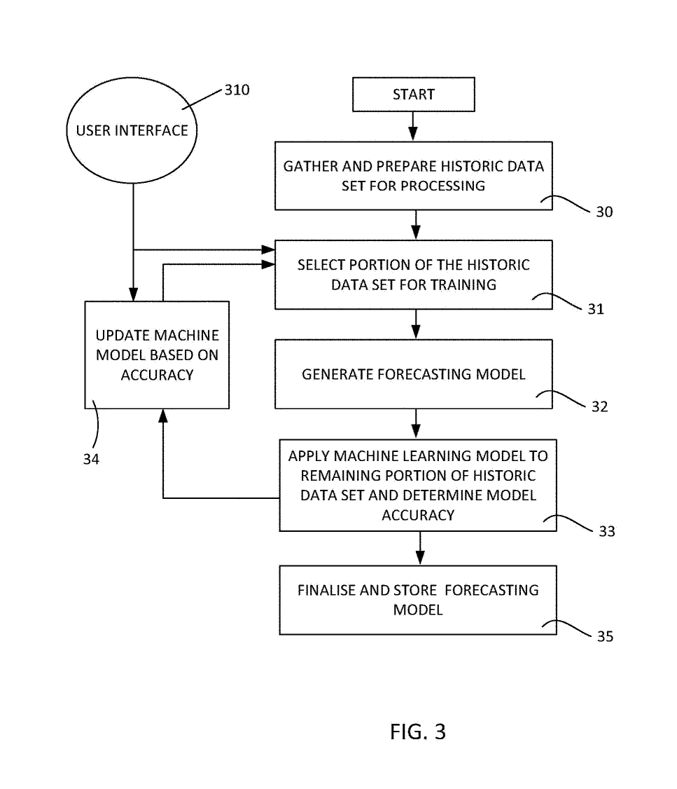

According to one embodiment, the prediction model is generated by the following exemplary process, illustrated by FIG. 3. At step 30, the historical data set from at least one year's data is gathered and prepared by the system 100;

As discussed above, the historical data set is required to span at least one year to enable the prediction model to forecast visitation for the following year. The model may utilize multiple years of data to thereby analyze the year-on-year growth rate. Alternatively, the model may reference a user provided input to manually manipulate this. Manipulation may be in the form of application or adjustment of weighting applied to one or more visitation factors to alter their influence on the outcome of the machine learning process.

At step 31, a temporal selection of the historical data set is made;

The machine learning process is applied to a temporal selection of the historical data set, then the forecasting model outcome is used to forecast visitation data for the remainder of the temporal period of the data set that was not selected. The temporal selection may be made by a user via the user interface or it may be a predetermined selection configured as part of the training process.

At step 32, a forecasting model is generated by the outcome of the application of the machine learning process which has analyzed the influence of each factor in the visitation data set; Generally, the forecasting model is generated by a process including the steps of: analyzing a set of data comprising factors relating to historic visitation at the venue to determine a hierarchy of the factors; then generating a forecasting model based on the determined hierarchy of factors. The forecasting model is then able to be applied to new and/or historic data from the venue to be forecasted, and/or new and/or historic data from a similar venue, to thereby forecast visitation at the venue.

The set of factors may be any one or more of the abovementioned factors 1-16, however to achieve highly accurate forecasting results, at least factors 1-9 are required. Additional factors 10-16 may improve the accuracy of the forecast. However, these factors are often circumstantial to the venue to be forecasted. Each of the factors analysed is assigned to a hierarchy based on their determined influence of historic visitation at the venue. The forecasting model is generated based on the outcome of the analysis of the set of the factors and their influence on the historic data. The application of the machine learning process is the most efficient way to process the historical data in order to determine which factors in the set have the most influence on visitation. However, other autonomous or manual processes may be used where appropriate.

At step 33, the forecasting model is used to generate visitation date for the remaining temporal period of the historic visitation set. The accuracy of the forecasting model is therefore able to be evaluated at this stage. If the prediction model is determined to be inaccurate, the process may take step 34 where the machine learning model can be further trained and steps 31, 32 and 33 repeated to test for improved accuracy.

The outcome of the machine learning process occurs at step 35 where adequate training of has taken place. The outcome is a forecasting model that can be applied to historic visitation data to thereby forecast visitation for a venue. The forecasting model is stored by the processor 301 in the storage module 302 for retrieval as desired.

In a preferred embodiment, a different temporal selection of the historical data set is made each time the machine learning model is retrained. For example, for a historical data set spanning 12 months, in a first instance, a 6 month portion of the data set is selected. The prediction model can then be applied to forecast visitation data for the remaining 6 months. During a subsequent retraining step, a different temporal selection is made such as 7 months. The prediction model can then be applied to forecast visitation data for the remaining 5 months. And so on.

During any machine learning process, the above described primary factors 1-9 are used to generate the forecasting model. Any one or more of the additional secondary factors may be used where appropriate to the venue. For example, for venues located in cities near large bodies of water, the presence of a cruise ship may be an influential factor. Conversely, for venues in landlocked cities, the cruise ship factor is irrelevant. In some embodiments, the selection of the chosen machine learning algorithm and factors are closely tuned to the mix of factors and preparation of data provided in the data set.

As mentioned, the particular machine learning model selected for use may also be changed and in preferred embodiments, more than one model is applied to the data set and the outcomes evaluated. Evaluation of the outcome produced by each machine learning model may be made by the determination of a “fit”. Evaluation of the fit include metrics such as the Root mean squared error (RMSE); R̂2; Measures of accuracy, such as 1−abs(predicted−observed)/observed; and training time. The outcome of the fit determination is also stored and optionally displayed to the user on the user interface which may prompt manual intervention or selection of a particular model over another. The outcome of the fit determination may be analyzed by a user or compared to the fit determinations of other machine learning models, with the final prediction model being produced from the machine learning model with the best fit, and/or the fastest processing time. A user may opt to select one machine learning model over another for reasons including a faster processing time, even though the fit may not be as good as another model. The particular model selected may therefore depend on the size of the data set to be processed, the processing time required, the amount of time available, and the time taken to process the data relative to other models and their associated fit.

In some embodiments, the machine learning model is retrained ten times which will be discussed further below. This produces a prediction model which has good accuracy for future visitation forecasting.

In one exemplary embodiment, a cross-validation technique (k-fold cross-validation set to 10-fold) was used to evaluate forecasting models. This technique helps to assess and improve the accuracy of the forecast by performing it various times under different circumstances. The RMSE for getting a gross idea of algorithm performance. R Squared (R̂2 or coefficient of determination) provides a “goodness of fit” measure for the forecast of the observed data. This technique helps to assess the model's fit to explain the data, and therefore provides a proxy for determining the model's accuracy. For example, a particular machine learning model was chosen to have the best performance overall by having the lowest RMSE, highest R̂2, and second shortest training time.

The outcome of the prediction model is a forecast of visitation footfall or admission at a venue that is based the historic data set provided. The forecast may be hourly, where hourly data is available in the historic data set; or daily, where daily data is available. Ultimately the outcome is determined for a desired time period. In some instances, a venue operator may request a forecast of a particular time period or date range such as days or months. In other instances, the prediction model may be used to generate a forecast into the future as far as may be useful. For example, a period of 15 months.

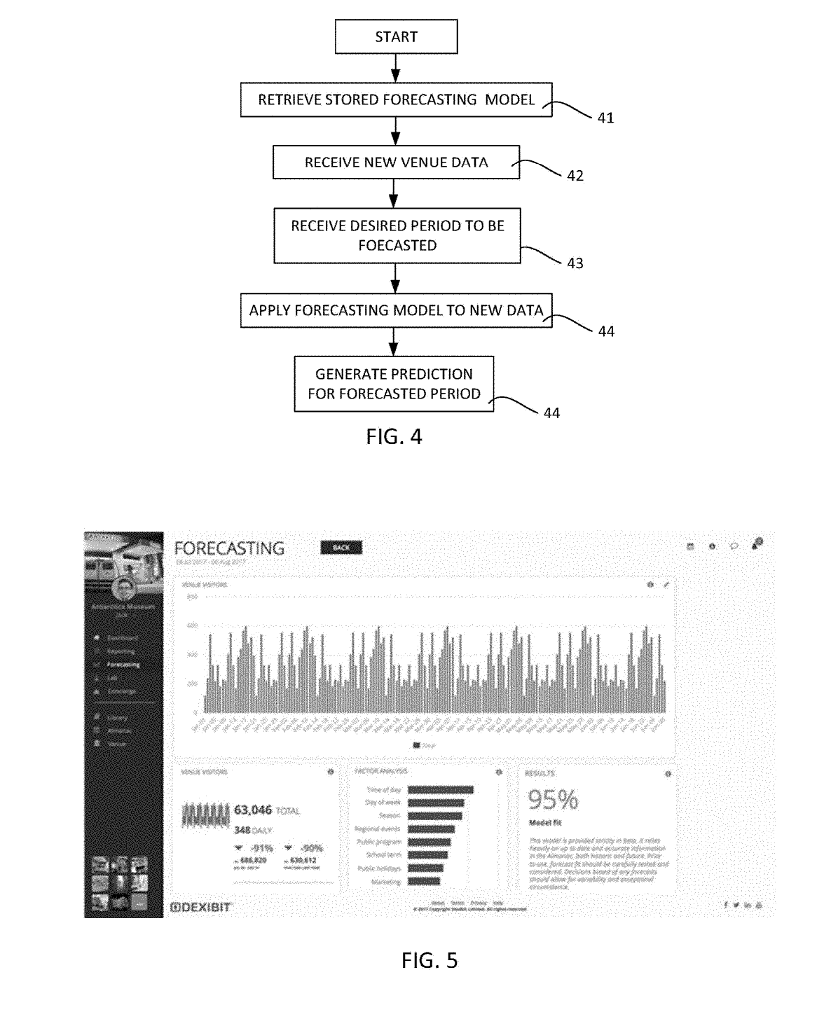

FIG. 4 illustrates the forecasting process. At step 41, the forecasting model is retrieved, for example, from the storage module 302. At step 42, new venue data is received. For example, the new venue data may be a venue unrelated to the venue from which the forecasting model was generated and trained. The new venue will typically have its own data set including several of the visitation factors required for application of the forecasting model. Where one or more factors are not provided by the venue, third party information sources may be queried including weather data providers and almanac sources. At step 43, a desired time period is received. The desired time period is typically stipulated by the venue or may be specified as part of a commercial service offering. At step 44, the forecasting model is applied to the new venue data including related data provided by any third parties. The visitation forecast is generated at step 44 by the outcome of the application of the forecasting model to the data.

The forecast may be presented to a user by emission of raw data, summary or graphical representation provided to the output interface. For example the processor may be configured to display the forecasted visitation data against a calendar to communicate the forecast results. Further, a daily or hourly prediction of the number of visitors through a door, expressed either in numbers, as a summary, or as a graph are possible. If not displayed immediately, then predicted values are stored. The results could be passed to a system rather than a human user.

FIG. 5 shows a graphical illustration of how visitation data may be presented. Here, a daily visitation forecast is shown for a 6 month time period. The visualization of the forecast data is readily interpreted for decision making.

The outcome of the prediction model may include short term and/or long term forecasting. For example, a visitation forecast that works out how many people will come to a venue may be a short term i.e. up to 14 days and down to the hour. Further, plus long range i.e. up to 15 months and down to the day are possible.

To maintain upkeep of the forecasting model as new venue data becomes available. One or more further processes may be applied to ensure upkeep and ongoing accuracy of the model. In some embodiments, the outcomes of the forecasting model are calculated and compared against visitation data retrieved from the venue.

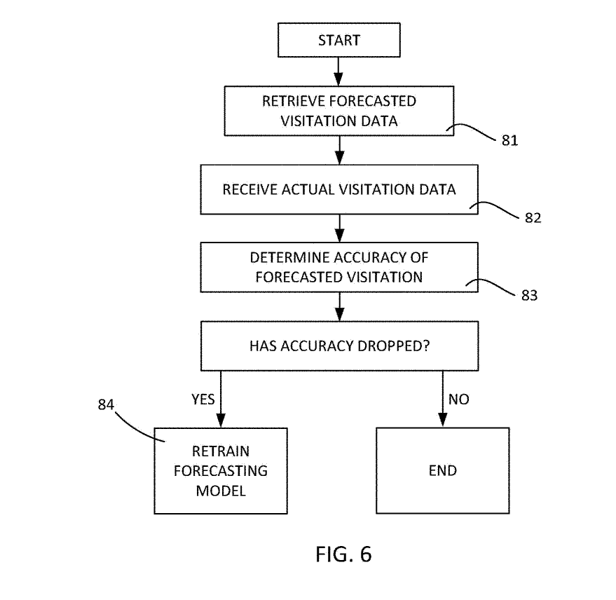

FIG. 6 shows a diagram of the process where at step 81 forecasted visitation data is assembled. At step 82, actual visitation data is retrieved from a venue. The actual visitation data corresponds to a period the prediction model generated forecasted visitation date for, at some historic occasion. At step 83, the accuracy of the forecasted visitation data is determined. The accuracy can be determined by, for example, directly comparing forecasted visitation with actual visitation. The comparison can be made at any desired temporal resolution that corresponds to the temporal resolution of the data under analysis. The outcome of the comparison is a determination that the accuracy of the forecasting model is tracking to the actual data, or not. If the forecasting model exhibits a drop in accuracy, for example, by exhibiting a trend or increase in the frequency of inaccurate forecasts, a retraining process 84 step may be initiated. Any retraining process that is subsequently undertaken may incorporate the newly acquired visitation data used for the comparison.

The embodiments discussed in this specification have shown to produce a forecasting model that is highly accurate (up to 95%), highly granular (down to the hour) and able to be forecast a long time (up to 15 months) in advance.

Incorporation of a large variety of factors is possible with a very short processing time (minutes, rather than the months it would traditionally take to complete a manual analysis for forecasting).

Therefore the above described methods are implemented for the provision of computerized forecasting of venue visitation. The forecasting is based on data comprising historic visitation data for any particular venue where forecasting is desired, and a contextual data set comprising a set of defined factors which may have impact on the attendance at the venue at a given time. As discussed above, the factors include the type of day (weekday or weekend); day of week; Month; Season; School term; Public holiday; and internal exhibition or event information at the venue. Each of the data sets comprises temporal reference data so that the influence of each factor on the venue visitation at particular times can be determined. The historic visitation data comprises footfall or attendance data at one or more venues, and temporal reference, data comprises time of day, including time intervals of a minute, minutes, an hour, and/or hours.

The venue forecasting model is built by using a machine learning process to identify influences between the factors in the contextual data set and the historic visitation data, relative to the temporal reference data. The machine learning process produces a function or model which draws a correlation or influence between the visitation data and the contextual data. That model can then be used to forecast future venue visitation providing future contextual data and a temporal reference, such as future day or days, to the model. From this data, the model generates an output indicative of the venue visitation forecast for at least the future temporal reference. That output can be used to generate a display, or control one or more building amenities at least at such a time which corresponds to the supplied future temporal reference.

As the visitation data and contextual data may be received from a variety of sources, data cleansing is required to harmonize the data for use. Data cleansing may involve preparation of the defined set of factors by a process of selecting factors from a broader contextual data set based on one or more criteria. The criteria generally relates to the venue itself, such as whether the venue is near the sea and may see cruise ships docking nearby, or in weather stable locations such that weather data is unlikely to have impact. An operator would typically oversea selection of the contextual data. However, the machine learning process may determine that particular contextual data factors have very low impact on visitation. Conversely, the machine learning process may determine other factors have a high influence which may indicate that factors with increased detail may be advantageous.

An operator may select factors manually based on prior knowledge, or may select factors based on relative influence determined by the machine learning process. The operator is responsible for providing interactions operable to classify a state associated with each defined factor in the contextual data set.

Classification of the factors may be achieved by application of a filter to create overlapping, at least in part, temporal reference data associated with each factor in the defined set of factors. Further, where data is incomplete, interpolation and/or extrapolation of missing data can be applied. Where data has more variability than desired, quantizing of that data to reduce the data resolution may be desirable.

In some embodiments, the above described venue visitation forecast methodology is used for the generation of a building control signal carrying information. The signal contains information indicative of predicting occupants in a building based on data comprising historic visitation data and a contextual data set comprising a set of defined factors. When the forecast is generated, an operator may direct via a control interface a processor to generate the building visitation forecasting model based on the determined influence associated with each defined factor. The building visitation forecasting model may generate a visitation forecast by the steps of inputting to the forecasting model, via a control interface, a future temporal reference for the desired building visitation forecast and future contextual data set for at least the future temporal reference to thereby produce a building visitation forecast, then generating the building control signal based on the building visitation forecast for the future temporal reference.

The building control signal is operable to facilitate control of one or more building amenities which may include ventilation equipment for heating or cooling, proactive maintenance of equipment, dynamic power consumption, and the provision of electrical facilities such as elevators, lighting, and media equipment.

It is to be understood that the present invention is not limited to the embodiments described herein and further and additional embodiments within the spirit and scope of the invention will be apparent to the skilled reader from the examples illustrated with reference to the drawings. In particular, the invention may reside in any combination of features described herein, or may reside in alternative embodiments or combinations of these features with known equivalents to given features. Modifications and variations of the example embodiments of the invention discussed above will be apparent to those skilled in the art and may be made without departure of the scope of the invention.

1. A method of computerized forecasting of venue visitation based on data comprising historic visitation data and a contextual data set comprising a set of defined factors, wherein each of the data sets comprises temporal reference data, the method comprising the steps of:
a. building a venue visitation forecasting, model by the steps of:
i. receiving the historic visitation data including temporal reference data;
ii. receiving the contextual data set comprising a set of defined factors, each of the set of defined factors having temporal data overlapping, at least in part, to the historical data temporal reference;
iii. applying a machine learning process to determine the influence associated with each defined factor in the contextual data set to the historic visitation data for overlapping, at least in part, a temporal reference; and
iv. generating the venue visitation forecasting model based on the determined influence associated with each defined factor; and
b. applying the venue visitation forecasting model to generate a visitation forecast by the steps of:
i. receiving a future temporal reference for the desired visitation forecast and future contextual data set for at least the future temporal reference;
ii. applying the forecasting model to the future contextual data for the future temporal reference to thereby produce a venue visitation forecast; and
iii. generating an output indicative of the venue visitation forecast for at least the future temporal reference.

2. The method of claim 1, wherein the contextual data set is produced by a data cleansing process comprising the steps of:
a. preparing the defined set of factors by a process of selecting factors from a broader contextual data set based on one or more criteria; and
b. receiving control inputs from an operator to provide interactions operable to classify a state associated with each defined factor in the contextual data set.

3. The method of claim 1, wherein the step to classify a state comprises:
a. application of a filter to create overlapping, at least in part, temporal reference data associated with each factor in the defined set of factors; and/or
b. interpolation and/or extrapolation of missing data; and
c. quantizing one or more raw factor data variables to a defined state.

4. The method of claim 1, wherein the influence associated with each defined factor comprises generating a hierarchy of defined factors in the contextual data set.

5. The method of claim 1, wherein determining the hierarchy comprises determining a weighting parameter for each of the defined factors in the contextual data set.

6. The method of claim 1, wherein the historic visitation data comprises historic data from two or more venues.

7. The method of claim 1, wherein the machine learning process comprises a combination of or ranking of two or more machine learning models.

8. The method of claim 1, wherein the historic visitation data and a contextual data set comprises at least one year of temporal data.

9. The method of claim 1, wherein the historic visitation data comprises footfall or attendance data at one or more venues and wherein temporal reference data comprises time of day, including time intervals of a minute, minutes, an hour, and/or hours.

10. The method of claim 1, wherein the defined factors in the contextual data set comprises:
a. Type of day (weekday or weekend);
b. Day of week;
c. Month;
d. Season;
e. School term;
f. Public holiday; and
g. Internal exhibition or event at the venue.

11. The method of claim 10, wherein the defined factors in the contextual data set further comprises external special regional event.

12. The method of claim 11, wherein the defined factors in the contextual data set further comprises weather data, weather state data, and cruise ship docking data.

13. The method of claim 12, wherein the defined factors in the contextual data set further comprises at least one of (a) year on year variation, (b) marketing spend, and (c) local tourism populations.

14. The method of claim 1, wherein the venue visitation forecasting model is generated by a process comprising:
a. application of a machine learning process to a first temporal portion of the historical visitation data set and the contextual data set to thereby determine a preliminary venue visitation forecasting model based on said first temporal portion;
b. testing the determined venue visitation forecasting model based on the first temporal portion to the remaining temporal portion of the historical visitation data set and the contextual data set to thereby determine a fit parameter representing the accuracy of the venue visitation forecast and the remaining temporal portion of the historical visitation data set;
c. repeating steps (a), (b) for different temporal portions of the of the historical visitation data set; and
d. refining the venue visitation forecasting model based on the fit parameter.

15. A system configured for the computerized forecasting of venue visitation based on data comprising historic visitation data and a contextual data set comprising a set of defined factors, each of the data sets comprises temporal reference data, the system comprising:
a. a memory and a processor
wherein the memory is configured to store the historic visitation data including the temporal reference data and the contextual data set comprising a set of defined factors, each of the set of defined factors having temporal data overlapping, at least in part, to the historical data temporal reference; and
wherein the processor is configured to execute instructions to compute a computerized building of a venue forecasting model, including the steps of:
i. applying a machine learning process to determine the influence associated with each defined factor in the contextual data set to the historic visitation data for overlapping, at least in part, a temporal reference; and
ii. generating the venue visitation forecasting model based on the determined influence associated with each defined factor;
wherein the instructions further comprise application of the venue visitation forecasting model to generate a visitation forecast by the steps of:
i. receiving a future temporal reference for the desired visitation forecast and future contextual data set for at least the future temporal reference;
ii. applying the forecasting model to the future contextual data for the future temporal reference to thereby produce a venue visitation forecast; and
iii. generating an output indicative of the venue visitation forecast for at least the future temporal reference.

16. A method of generating a building control signal carrying information indicating or predicting occupants in a building based on data comprising historic visitation data and a contextual data set, comprising a set of defined factors; each of the data sets comprises temporal reference data, the method comprising the steps of:
a. the computer processor implemented building of a venue forecasting model comprising the steps of:
i. directing, via a control interface, the processor to receive the historic building visitation data including temporal reference data;
ii. directing, via a control interface, the processor to receive the contextual data set comprising a set of defined factors, each of the set of defined factors having temporal data overlapping, at least in part, to the historical data temporal reference;
iii. directing, via a control interface, the processor to implement a machine learning process to determine the influence associated with each defined factor in the contextual data set to the historic visitation data for overlapping, at least in part, a temporal reference; and
iv. directing via a control interface, the processor to generate the building visitation forecasting model based on the determined influence associated with each defined factor; and
b. applying the building visitation forecasting model to generate a visitation forecast by the steps of:
i. inputting to the forecasting model, via a control interface, a future temporal reference for the desired building visitation forecast and future contextual data set for at least the future temporal reference to thereby produce a building visitation forecast; and
ii. generating the building control signal based on the building visitation forecast for the future temporal reference.

17. The method of claim 16, wherein the building control signal is operable to facilitate control of one or more building amenities.

18. The method of claim 16, wherein the method further comprises control of one or more building amenities based on the building control signal.

19. The method of claim 16, wherein the processor is configured to receive new historic visitation data and a contextual data set, and wherein the method further comprises generating a new building control signal based on the new data.
